(19) United States
(12) Patent Application Publication
(10) Pub. No.: US 2012/0136671 A1
(43) Pub. Date: May 31, 2012

(54) MEDICAL DECISION SUPPORT SYSTEM AND METHOD

(75) Inventors: Ram I. Alt, Tel Aviv (IL); Arieh Leon Dranger, Los Angeles, CA (US); Yosef Marko, Rosh H-Ayin (IL); Gilad Moran, Rehovot (IL); Reynolds James Saunders, Beverly Hills, CA (US); Eitan Kenneth, Gan Yavne (IL)

(73) Assignee: MEDIVIZ SYSTEMS, INC., Los Angeles, CA (US)

(21) Appl. No.: 12/311,878

(22) PCT Filed: Oct. 16, 2007
(86) PCT No.: PCT/US07/22061

§ 371 Date: Apr. 16, 2009

Related U.S. Application Data
(60) Provisional application No. 60/852,900, filed on Oct. 18, 2006.

(51) Int. Cl. G06Q 50/22

(52) U.S. Cl. 705/2

(57) ABSTRACT

A medical scheduling system and method associating medical procedures and with medical resources, associating patients with medical procedures to form medical procedure instances, scheduling each medical procedure instance according to the availability of the medical resource associated with the medical procedure and according to medical priorities associated with the patients, the medical procedures and the resources. The A medical scheduling system and method additionally operative to simulate the effect of probable situations and events on the execution of the scheduled operation and to provide decision support information for contingency planning.

### RELATIONSHIP TO EXISTING APPLICATIONS

The present application claims priority from U.S. Provisional Patent Application No. 60/852,900, filed 18 Oct. 2006, and from PCT Application No. PCT/US2007/022061 filed 16 Oct. 2007 which is a Continuation-in-Part from said Provisional Patent Application No. 60/852,900, the contents of which are hereby incorporated by reference.

### FIELD AND BACKGROUND OF THE INVENTION

The present invention relates to a decision support system and method for managing medical operations and, more particularly, but not exclusively to a method and system for real-time scheduling medical procedures in a medical organization.

The main function of a hospital, or any other medical organization, is to use medical procedures to treat patients. Efficient operation of the hospital, as in any other organization, requires careful planning. However, at best, only about two thirds of the medical procedures are planned significantly ahead of their execution.

Planned procedures are usually scheduled on a first-come-first-served basis, depending on the availability of the required resources (with the significant exception of block booking, in which a block of time is reserved for a particular clinician until a specified deadline). The required resources may include an operating room, personnel of various required professions, medical instruments, medical supplies and medical devices. In most instances, operating rooms are general-purpose and capable of using all resources, so scheduling is flexible.

It is possible but uncommon to schedule resources for specific types of procedures ahead of scheduling the specific procedures. For example, a small number of operating rooms are scheduled for a certain time slot, such as a certain day, for a certain type of surgical operation such as neurosurgery with intraoperative MRI. Patients in need for such type of procedure are then scheduled to that time slot, according to their medical priority and other considerations.

Even when scheduled operations can be performed as, and when, planned, other patients, hospitalized because of emergency illness and trauma, may require more immediate surgical treatments. Thus, such ad-hoc events very frequently alter the course of previously scheduled operations. Since emergency operations occur very often, it is common in large hospitals to allocate resources in advance for emergency operations.

It is also common for a considerable percent of planned operations to be cancelled. However, in many cases, the cancellation occurs too late to enable rescheduling of another case into the vacated time slot.

In a substantial number of hospitals, some of the operating rooms, pre-operative areas and PACUs (Post-Anesthesia Care Units) are located in different buildings. This makes it even more difficult for the hospital management and to get real-time situation awareness. This method of very crude resource scheduling results in substantially inefficient use of the hospital resources on one hand, and unnecessary delays of treatments to patients on the other.

Possible reasons for the low operating room utilization are the complexity of the medical system, the need to treat many patients concurrently and the numerous types of procedures and their variations (i.e., protocols). Most procedures contain several phases, whose times are independent of one another, and which require making medical decisions based on medical results obtained during preceding phases. This results in over-allocation of resources in order to cover possible permutations of procedural details. Frequently, resources are unavailable because they have been allocated to procedures in which they are not actually being used. Alternatively, resources are idle because they were de-allocated without anybody knowing they had become available; thus there is no time to reallocate them to pending operations. The principles described above regarding operating rooms are also pertinent to other medical facilities, such as imaging facilities, (X-ray, MRI, ultra-sound, etc.), irradiation facilities, cardiac catheterization facilities, etc.

There is thus a widely recognized need for (and it would be highly advantageous to have) an operating room decision-support center which minimizes the above limitations.

### SUMMARY OF THE INVENTION

According to one aspect of the present invention there is provided a medical real-time patient flow monitoring and reporting method including:

a) defining at least one medical procedure, each medical procedure containing a sequence of phases;

b) associating the medical procedure with a patient to form a medical procedure instance;

c) monitoring the progress of the medical procedure instance from phase to phase; and

d) reporting the progress of the medical procedure in real-time.

Also, according to another aspect of the present invention there is provided a medical real-time patient flow monitoring, reporting and/or analysis method wherein the sequence of phases contains several alternative branches.

Also, according to yet another aspect of the present invention there is provided a medical real-time patient flow monitoring and reporting and/or analysis method wherein each phase is associated with at least one of the following:

a) at least one staff member responsible to report progress of the phase; and

b) at least one staff member responsible to receive a report associated with progress of the phase.

Also according to still another aspect of the present invention there is provided a medical real-time patient flow monitoring and reporting and/or analysis method wherein the staff member is identified by at least one of:

a) personal identity,

b) position identity, and

c) location identity.

Additionally according to one aspect of the present invention there is provided a medical scheduling method including:

a) associating at least one of the medical resources with a medical procedure;

b) associating the medical procedure with a patient to form a medical procedure instance; and

c) scheduling the medical procedure instance according to availability of the medical resource(s) associated with the medical procedure;

wherein the medical resources includes at least one each of a medical staff member, a medical device, and an operating facility.

According to another aspect of the present invention there is provided a medical scheduling method wherein the medical staff members are at least one of the following: a physician, an anesthesiologist, a surgeon, a nurse, and a technician.

According to still another aspect of the present invention there is provided a medical scheduling method including:

a) associating medical resources with a medical procedure;

b) associating the medical procedure with a patient to form a medical procedure instance;

c) scheduling the medical procedure instance according to availability of the medical resource(s) associated with the medical procedure; and

d) assigning a predicted time length to the medical procedure;

wherein the scheduling of the medical procedure instance being performed varies according to the predicted time length.

According to further another aspect of the present invention there is provided a medical scheduling method including:

a) associating medical resources with a medical procedure;

b) associating the medical procedure with a patient to form a medical procedure instance;

c) scheduling the medical procedure instance according to availability of the medical resource associated with the medical procedure; and

d) assigning a medical priority based on the patient and\or the medical procedure instance and\or the medical resource;

wherein the scheduling of the medical procedure instance being performed varies according to the priority.

Further according to another aspect of the present invention there is provided a medical scheduling method wherein the scheduling of the medical procedure instance being performed varies according to at least two of:
i) the priority assigned to the patient;
ii) the priority assigned to the procedure; and
iii) the priority assigned to the resource.

Still further according to another aspect of the present invention there is provided a medical scheduling method including:

a) associating medical resources with a medical procedure;

b) associating the medical procedure with a patient to form a medical procedure instance;

c) scheduling the medical procedure instance according to availability of the medical resource associated with the medical procedure;

d) providing a list of available medical resources; and

e) performing at least one of:
i) allocating at least one medical resource from the list of available medical resources to the instance of medical procedure;
ii) marking as unavailable at least one medical resource in the list of available medical resources upon scheduling of or beginning the instance of medical procedure; and
iii) marking as available at least one medical resource in the list of available medical resources upon completion or cancellation of a medical procedure instance being scheduled.

Additionally according to another aspect of the present invention there is provided a medical scheduling method wherein the list of available medical resources contains time values for each medical resource.

Also according to another aspect of the present invention there is provided a medical scheduling method wherein the time values are at least one of:
i) time of availability; and
ii) time of unavailability of the medical resource.

According to yet another aspect of the present invention there is provided a medical scheduling method including:

a) associating at least one medical resource with a medical procedure;

b) associating the medical procedure with a patient to form a medical procedure instance;

c) scheduling the medical procedure instance according to availability of the medical resource associated with the medical procedure;

d) providing a list of available medical resources;

e) performing of:
i) allocating a medical resource from the list of available medical resources to the instance of medical procedure;
ii) marking as unavailable a medical resource in the list of available medical resources upon the scheduling or beginning of the instance of medical procedure; and
iii) marking as available medical resource in the list of available medical resources upon of completion and cancellation of a medical procedure instance being scheduled; and

f) defining at least one of:
i) resource start-time, being a predefined time after beginning the medical procedure at which the medical resource is required; and
ii) resource end-time, being a predefined time after beginning the medical procedure at which the medical resource is released;

wherein at least one of the steps of allocating, marking as unavailable, and marking as available is associated with variation or logging of the start-time and the end-time.

According to still another aspect of the present invention there is provided a medical scheduling method wherein the medical procedures contains a plurality of sub-procedures and wherein the sub-procedures is at least one of:
i) selectable, wherein at least one of another sub-procedure is cancelled or deferred;
ii) concurrent, wherein at least one of another of the sub-procedures is executed during the same time; and
iii) sequential, wherein execution of at least one of the sub-procedures starts only after completing at least one of another sub-procedure.

Wherein the steps of scheduling, allocating, marking as unavailable, marking as available, assigning the medical priority, and scheduling according to the priority are executed in accordance with the sub-procedure being at least one of the following: selectable, concurrent or sequential.

According to still further another aspect of the present invention there is provided a medical scheduling method including:

a) associating medical resource with a medical procedure;

b) associating the medical procedure with a patient to form a medical procedure instance;

c) scheduling the medical procedure instance according to availability of the medical resource associated with the medical procedure;

d) providing a decision point before beginning sub-procedure; and

e) performing, at the decision point, at least one of:
i) determining of next the sub-procedure; and
ii) assigning the priority to of next the sub-procedures.

According to yet further another aspect of the present invention there is provided a medical scheduling method including:

a) associating medical resource with a medical procedure;

b) associating the medical procedure with a patient to form a medical procedure instance;

c) scheduling the medical procedure instance according to availability of the medical resource associated with the medical procedure; and

d) scheduling the instance of the medical procedure in stand-by;

wherein a procedure scheduled in stand-by would be executed if the required resources are made available due to early completion or cancellation of other procedures.

According to even further another aspect of the present invention there is provided a medical scheduling method including:

a) associating medical resource with a medical procedure;

b) associating the medical procedure with a patient to form a medical procedure instance;

c) scheduling the medical procedure instance according to availability of the medical resource associated with the medical procedure;

d) scheduling the instance of the medical procedure in stand-by;

e) rescheduling the instance of the medical procedure to a later time; and

f) rescheduling for execution the instance of the medical procedure scheduled in stand-by.

Still further according to another aspect of the present invention there is provided a decision support method for managing a plurality of concurrent medical procedures, the method containing:

a) defining a plurality of medical procedures;

b) providing a sequence of phases for each the medical procedure;

c) associating medical resource with each the phase of the medical procedure;

d) providing a list of available medical resources;

e) assigning medical procedure to each of a plurality of patients;

f) assigning medical resource to each phase of each medical procedure assigned to each of the plurality of patients; and

g) scheduling at least one phase of at least one medical procedure for at least one of the plurality of patients according to availability of the medical resources.

Even further according to another aspect of the present invention there is provided a decision support method for managing a plurality of concurrent medical procedures, the method containing:

a) defining a plurality of medical procedures;

b) providing a sequence of phases for each the medical procedure;

c) associating medical resource with each the phase of the medical procedure;

d) providing a list of available medical resources;

e) assigning medical procedure to each of a plurality of patients;

f) assigning medical resource to each phase of each medical procedure assigned to each of the plurality of patients;

g) scheduling phase of medical procedure for of the plurality of patients according to availability of the medical resources; and

h) reporting at least one of availability and unavailability of medical resources for at least one phase of at least one medical procedure of at least one of the plurality of patients.

Also according to another aspect of the present invention there is provided a Decision support method for managing a plurality of concurrent medical procedures, the method containing:

a) defining a plurality of medical procedures;

b) providing a sequence of phases for each the medical procedure;

c) associating medical resource with each the phase of the medical procedure;

d) providing a list of available medical resources;

e) assigning medical procedure to each of a plurality of patients;

f) assigning medical resource to each phase of each medical procedure assigned to each of the plurality of patients;

g) scheduling phase of medical procedure for of the plurality of patients according to availability of the medical resources;

h) monitoring execution of the scheduled medical procedures; and
i) reporting at least one of:
i) availability of medical resources;
ii) unavailability of medical resources; and
iii) anticipated requirement for medical resources;

for at least one phase of at least one medical procedure of at least one of the plurality of patients.

Additionally according to another aspect of the present invention there is provided a decision support method for managing a plurality of concurrent medical procedures, the method containing:

a) defining a plurality of medical procedures;

b) providing a sequence of phases for each the medical procedure;

c) associating medical resource with each the phase of the medical procedure;

d) providing a list of available medical resources;

e) assigning medical procedure to each of a plurality of patients;

f) assigning medical resource to each phase of each medical procedure assigned to each of the plurality of patients;

g) scheduling phase of medical procedure for of the plurality of patients according to availability of the medical resources;

h) monitoring execution of the scheduled medical procedures;

i) reporting at least one of:
i) availability of medical resources;
ii) unavailability of medical resources; and
iii) anticipated requirement for medical resources;

for at least one phase of medical procedure of at least one of the plurality of patients;

j) rescheduling of the phases; and

k) enabling a user to reschedule at least one of the phases;

wherein at least one of the rescheduling of a phase, and enabling a user to reschedule, being according to at least one of:
i) the availability of medical resources;
ii) the unavailability of medical resources; and
iii) the anticipated requirement for medical resources.

According to another aspect of the present invention there is provided a patient flow monitoring system containing:

a) a database unit containing a plurality of medical procedures wherein each medical procedure contains a sequence of phases;

b) a user interface operative to enable a user to associate the medical procedures with at least one patient to form a medical procedure instance;

c) a monitoring unit operative to monitor execution of the medical procedure instance; and

d) a reporting unit operative to provide a user with a progress report execution of the execution of the medical procedure instance in real-time.

Further according to another aspect of the present invention there is provided a patient flow monitoring system wherein the monitoring unit contains a user input device operative to receive from a user an indication of the execution of the medical procedure instance.

Still further according to another aspect of the present invention there is provided a patient flow monitoring system wherein the reporting unit contains a user output interface operative to provide a user with an indication of the execution of the medical procedure instance.

Even further according to another aspect of the present invention there is provided a patient flow monitoring system wherein the monitoring unit and the reporting unit comprise a user identification module operative to identify the user according to personal identity and/or position identity (such as function, profession, etc.) and/or location identity (where the user is currently located).

Also according to another aspect of the present invention there is provided a medical scheduling system containing:
a database unit containing a plurality of database records, each record describing one of a medical procedure and a medical resource;
b) a first user interface operative to enable a user to associate the medical resources with the medical procedures with at least one patient to form a medical procedure instance;
c) a second user interface operative to enable a user to associate one of the medical procedures with a patient to form a medical procedure instance;
d) a third user interface operative to enable a user to schedule the medical procedure instance according to availability of the at least one medical resource associated with the medical procedure;
wherein the medical resources containing a medical staff member, and/or a medical device, and/or an operating facility.

According to still another aspect of the present invention there is provided a medical scheduling system additionally containing a processing module operative to schedule of a plurality of medical procedure instances upon request from the user.

Further according to another aspect of the present invention there is provided a medical scheduling system wherein the user is either a physician, an anesthesiologist, a surgeon, a nurse, a paramedic, or a technician.

Still further according to another aspect of the present invention there is provided a medical scheduling system wherein the fourth user interface is additionally operative to enable a user to assign a time length to the medical procedure and wherein the third user interface enables the user to schedule the medical procedure instance according to the time length.

Even further according to still another aspect of the present invention there is provided a medical scheduling system wherein the fourth user interface is additionally operative to enable the user to assign a medical priority to the medical procedure instance and to schedule the medical procedure instance additionally according to the procedure priority.

Also, according to another aspect of the present invention there is provided a medical scheduling system wherein the fourth user interface is additionally operative to enable the user to assign a medical priority to the patient and to schedule the medical procedure instance additionally according to the patient priority.

Also, according to still another aspect of the present invention there is provided a medical scheduling system wherein the fourth user interface is additionally operative to enable the user to assign a medical priority to the medical resource and to schedule the medical procedure instance additionally according to the resource priority.

Additionally, according to another aspect of the present invention there is provided a medical scheduling system wherein the fourth user interface is additionally operative to enable the user to assign a medical priority to the medical resource and to schedule the medical procedure instance additionally according to at least two of:
i) the priority assigned to the patient;
ii) the priority assigned to the procedure; and
iii)the priority assigned to the resource.

According to another aspect of the present invention there is provided a decision support system containing:
a) a database unit containing a plurality of database records, each record describing one of a medical procedure containing a plurality of phases, a medical resource type, a medical resource instance of the medical resource type, and a patient;
b) a first user interface operative to enable a user to associate the medical resource types with the phases;
c) a second user interface operative to enable a user to associate one of the medical procedures with one of the patients to form a medical procedure instance;
d) a third user interface operative to enable a user to assign the medical resource instances with one phase of the medical procedure instances according to the medical resource type associated with the phase and according to availability of the medical resource instance; and
e) a user output interface operative to provide indication of scheduling of execution of the phase.
wherein the decision support system is operative to schedule a plurality of concurrent medical procedures.

Also, according to another aspect of the present invention there is provided a decision support system wherein the user output interface is additionally operative to provide an indication of scheduling according to any of:
i) a type of medical procedure;
ii) a phase of medical procedure;
iii) a type of medical resource;
iv) a medical staff member; and
v) a patient.

According to still another aspect of the present invention there is provided a decision support system additionally containing a processing module operative to process the database to provide a schedule of the plurality of the medical procedure instances according to the availability of the medical procedure instances.

Further according to another aspect of the present invention there is provided a decision support system additionally containing a monitoring module operative to monitor execution of the scheduled medical instances and to report any of: availability of medical resources, unavailability of medical resources, and anticipated requirement for medical resources, for at least one phase of at least one medical procedure of the plurality of patients.

According to another aspect of the present invention there is provided a medical-scheduling simulation system containing:
a) a medical scheduling system;
b) database management system containing database records describing any of: a plurality of planned medical events and a plurality of unplanned medical events;
c) a communication unit operative to communicate the plurality of planned medical events and the plurality of unplanned medical events from the database management system to the medical scheduling system;
d) a first user interface module operative to enable a user to instruct the database management system to communicate the planned medical events to the medical scheduling system to create at least one schedule of the plurality of planned medical events; and
e) a second user interface module operative to enable a user to instruct the database management system to communicate the unplanned medical events to the medical scheduling system to create at least one schedule of the plurality of planned medical events; and
f) a third user interface module operative to enable a user to instruct the medical scheduling system to create at least one simulated schedule of the plurality of planned medical events and the unplanned medical event.

According to still another aspect of the present invention there is provided a medical-scheduling simulation system additionally containing a fourth user interface module operative to provide the use with the simulated schedule.

Unless otherwise defined, all technical and scientific terms used herein have the same meaning as commonly understood by one of ordinary skill in the art to which this invention belongs. The materials, methods, and examples provided herein are illustrative only and not intended to be limiting. Except to the extend necessary or inherent in the processes themselves, no particular order to steps or stages of methods and processes described in this disclosure, including the figures, is intended or implied. In many cases, the order of process steps may vary without changing the purpose or effect of the methods described.

Implementation of the method and system of the present invention involves performing or completing certain selected tasks or steps manually, automatically, or any combination thereof. Moreover, according to actual instrumentation and equipment of preferred embodiments of the method and system of the present invention, several selected steps could be implemented by hardware or by software on any operating system of any firmware or any combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIG. 1 is a simplified block diagram of a medical real-time patient flow monitoring and reporting system, according to a preferred embodiment of the present invention.

FIG. 2 is a simplified block diagram of an operating-room decision-support center and its environment, according to a preferred embodiment of the present invention;

FIG. 3 is another simplified block diagram of the operating-room decision-support center and a hospital information system (HIS);

FIG. 4 is a simplified illustration of the operating-room decision-support center within a medical organization environment, according to a preferred embodiment of the present invention;

FIG. 5 is a simplified block diagram of a medical procedure data structure used by the operating-room decision-support center, according to a preferred embodiment of the present invention;

FIG. 6 is a simplified another block diagram of the operating-room decision-support center;

FIG. 7 is a simplified block diagram of an enhanced operating-room decision-support center, according to a preferred embodiment of the present invention.

### DESCRIPTION OF THE PREFERRED EMBODIMENTS

The present embodiments comprise systems and methods providing decision support for the management of medical operations in a medical organization. More particularly, but not exclusively the present embodiments comprise systems and methods for scheduling medical procedures in a medical organization.

The principles and operation of the system and the methods for decision support and/or scheduling of medical procedures, according to the present invention, may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments, of being practiced, or carried out in various ways. In addition, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text has the same use and description as in the previous drawings where it was described.

The present invention supports optimization of the operations of a medical organization to achieve at least one of the following goals:

1. Perform more medical procedures, and/or treat more patients,

2. Provide treatment to patients faster; and

3. Reduce the cost of operating the medical organization without decreasing the volume and the quality of the operations.

The present invention provides the optimization in at least one of two modes:

1. Performing automatic scheduling of medical procedures;

2. Providing decision support information to users responsible for the scheduling of medical procedures; and

3. Their combinations.

Providing the above services, the present invention preferably combines the following aspects:

1. Availability of resources;

2. Medical priorities; and

3. Economical value.

Medical priorities are obviously peculiar to medical situations and are of the highest importance for scheduling medical procedures and operations. Medical priorities are of a complex nature, depending on the combination of the nature of the illness, the nature of the medical procedure, and the medical status of the patient other than directly requiring the medical procedure. Furthermore, the medical priority may change dramatically in the course of the medical treatment.

Another aspect, which is peculiar to medical operations, is that a patient medical condition may deteriorate due to complications, and side effects of treatments, thus requiring more or different, resources, typically without warning.

Therefore, the present invention provides its services based on continuous monitoring of activities, preferably medical activities, and medically related, activities, within the medical organization.

Preferably, the services that the present invention provides are, including but not limited to:

i) real-time patient flow management;

ii) real-time operating room utilization management;

iii) detailed planning of medical procedures and real-time monitoring of their execution;

iv) prioritizing of patients, medical procedures, and resources, including but not limited to personnel, medical facilities and medical devices;

v) scheduling, and real-time rescheduling, of patients, medical procedures and resources, including but not limited to personnel, medical facilities and medical devices;

vi) on-line monitoring of compliance with regulations and policies;

vii) alert management and distribution;

viii) patients overbooking, scheduling in stand-by, contingency planning and resource trading;

ix) cost management and revenue planning; and

x) decision support information enabling authorized personnel to perform manual scheduling.

It is appreciated that the goals of the above services and functions is to increase the patients' well-being, to increase the capacity of the available resources, and to reduce the cost of operating the medical organization.

It is therefore appreciated that the present invention provides its services preferably continuously and preferably in real-time or at least in due time with the medical events and developments.

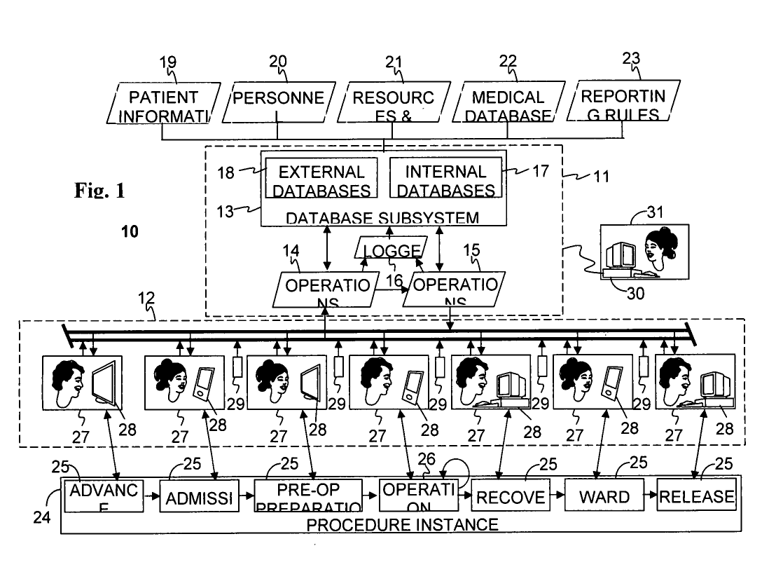

Reference is now made to FIG. 1, which is a simplified block diagram of a medical real-time patient flow monitoring and reporting system 10, according to a preferred embodiment of the present invention.

The medical real-time patient flow monitoring and reporting system 10 typically operated by a medical organization, such as a hospital, to monitor and report, in real-time, the progress of execution of medical procedures, within the medical organization.

Preferably, the medical real-time patient flow monitoring and reporting system 10 contains a processing center 11 and a distributed information collection and distribution subsystem 12. The processing center 11 preferably contains a database subsystem 13, a monitoring subsystem 14, and a reporting subsystem 15, which are all interconnected. Preferably, but optionally, the medical real-time patient flow monitoring and reporting system 10 also contains a logger 16. The database subsystem 13 preferably contains an internal database part 17 and optionally an external database part 18. The external database is typically contained within a hospital information system (HIS) or an Enterprise Resources planning (ERP) system. The database subsystem 13 preferably implemented using a conventional database management system (DBMS), preferably contains the following information, preferably implemented as databases:
patient information database 19,
personnel information database 20,
resources and facilities database 21,
Medical procedures database 22, and
Reporting and alerting rules database 23.

The medical procedures database preferably contains a list of medical procedures 24. Each such medical procedure preferably contains several phases 25. Typically, the phases of a procedure are arranged in a sequence, with or without branching into alternative sub-sequences. Procedure 24 of FIG. 1 presents a procedure constructed of a single sequence.

Preferably, the monitoring subsystem 14 and the reporting subsystem 15 contain user interfaces, preferably input user interfaces to receive information from user and output user interfaces to provide information to users. Preferably, the user interfaces are implemented as user terminals, user input and/or output devices, etc.

Typically, each phase of procedure 24 is executed in another ward, or facility, of the medical organization. However, some phases 25 may be executed within the same facility. For example, element 26 represent a plurality of operation phases 25 that are executed within an operating room. The phases 25 that make the element 26 are preferably arranged in a sequence, with or without branching into alternative sub-sequences of phases 25.

Preferably, each facility 27 of the medical organization, or at least each facility that takes part in at least one procedure 24, is equipped with a monitoring and/or a reporting user terminal 28, which is, preferably, a user input device enabling a user to input information. Preferably, there are also automatic monitoring devices 29, preferably available at the entries and/or the exits of the facility. The automatic monitoring devices 29 are operative to detect patients as they enter or exit the respective facility, preferably by detecting and identification device, such as an RFID (radio frequency identification device) preferably attached to the patient.

An administration workstation 30 is preferably provided, preferably within a control center 31, to program the medical real-time patient flow monitoring and reporting system 10. The administration workstation 30, which is, preferably, a user input device enabling a user to input information, preferably enabling a user to:
define medical procedures 24,
define phases that make each medical procedure 25,
define the arrangement of the phases within each medical procedure,
define monitoring rules for each phase of each medical procedure, and
define reporting rules for each phase of each medical procedure.

Preferably, the medical real-time patient flow monitoring and reporting system 10 enables a user to associate a procedure with a patient, thus creating a procedure instance. Preferably, the procedure instance is scheduled for execution ahead of the execution. However, a procedure instance can be created as a result of an emergency. Such emergency can be a patient arriving to the emergency room, or a patient developing medical complications within the medical organization. Once a procedure instance is created the medical real-time patient flow monitoring and reporting system 10 is able to monitor the execution of the procedure and to report the progress to all relevant reporting terminals.

The medical real-time patient flow monitoring and reporting system 10 therefore preferably supports real-time situation awareness throughout the medical organization. The medical real-time patient flow monitoring and reporting system 10 informs every relevant staff member of any event that the staff member should be aware of. Furthermore, based on the anticipated progress of the medical procedure instance and according to the structure of the medical procedure 24, the medical real-time patient flow monitoring and reporting system 10 informs each relevant staff member of anticipated future events. Thus, authorized staff members are able to plan ahead, and to schedule manpower and resources, to efficiently and effectively accommodate the upcoming events and developments.

Preferably, each staff member receives the relevant information according to authorization associated with the staff member personal identity, and/or with the position of the staff member (that is the profession or responsibility of the staff member), and/or with the location of the staff member.

The logger 16 preferably logs all the activities involved with the medical real-time patient flow monitoring and reporting system 10, including, but not limited to: all inputs to the operations monitoring 14, all outputs of the operations reporting 15, and all the inputs and outputs of the administration workstation 30. Preferably, all logged information is recorded with corresponding time-stamps to record the time of each information item.

It is appreciated that the medical organization using the medical real-time patient flow monitoring and reporting system 10 is typically a hospital. However, the medical real-time patient flow monitoring and reporting system 10 can also be used by larger organizations, or by smaller organizations. The medical real-time patient flow monitoring and reporting system 10 can also serve a clinic, or a chain of clinics, or a group of hospitals, or a region, such as a town. It is appreciated that the medical real-time patient flow monitoring and reporting system 10 can improve the efficiency of operating such organization, reduce the queue for treatments, reduce the cost of providing treatments, or improve the quality of the medical service. It is appreciated that the medical real-time patient flow monitoring and reporting system 10 can be effective in managing triage, especially for a large-scale situation involving several hospitals.

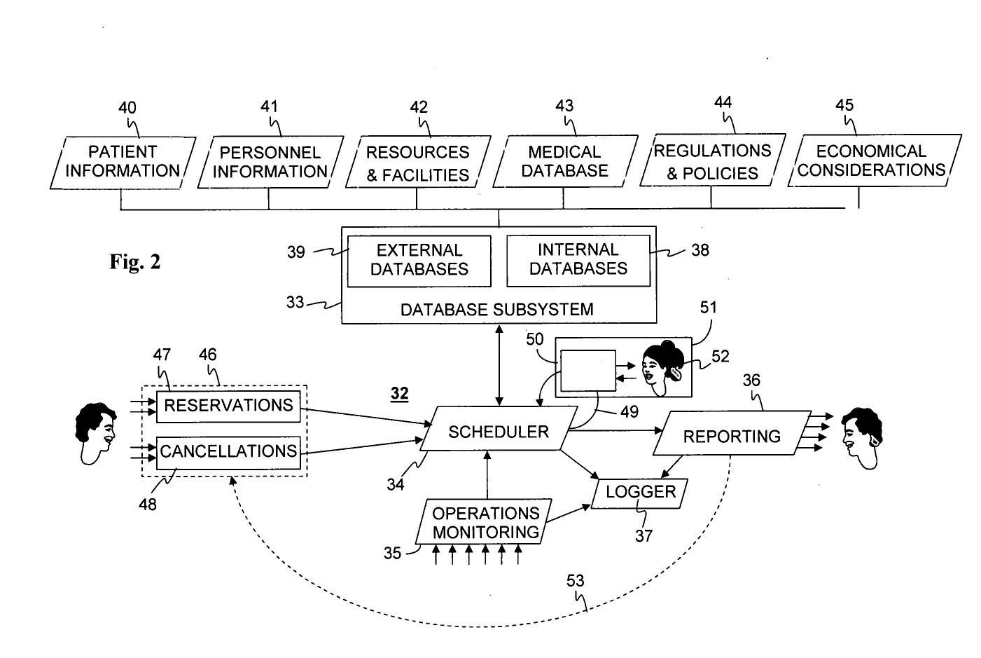

Reference is now made to FIG. 2, which is a simplified block diagram of an operating-room decision-support center 32 and its environment, according to a preferred embodiment of the present invention.

The operating-room decision-support center 32 of FIG. 2 preferably contains four main parts: database subsystem 33, scheduling subsystem 34, monitoring subsystem 35 and reporting subsystem 36. Preferably, but optionally, the operating-room decision-support center 32 also contains a logger 37.

The database subsystem 33 preferably contains internal databases 38 and external databases 39. The internal databases 38 are managed directly by the operating-room decision-support center 32, while the external databases 39 are managed by an external information processing system to which the operating-room decision-support center 32 interfaces with. The external information processing system is typically a hospital information system (HIS), and\or typically an enterprise resource planning (ERP) systems, typically using an external database management systems.

The database subsystem 33 preferably contains the following information, preferably in the form of databases, typically managed by the internal databases 38 or the external databases 39:

i) Patient information 40, preferably including, but not limited to, information about the patient, the patient's medical history, the current medical diagnosis, the planned medical procedure, the medical priority, other medical indications, associations with various instructions (including patient's or family instructions), regulations and policies, etc.

ii) Personnel information 41, preferably including, but not limited to, information about each member of the medical staff, their professions, authorizations, etc.

iii) Resources and Facilities 42, preferably including, but not limited to, operating rooms, wards, beds, and medical devices with their capabilities and capacities.

iv) Medical Database 43, preferably including, but not limited to, a list of medical procedures with their operational information. Such operational information preferably being:
required resources such as: personnel, facilities, and medical devices;
anticipated time of execution;
pre-conditions, such as specific tests and preparations;
priority;
statistics (e.g. probability of occurrence),
etc.
preferably the medical procedure is divided into phases, each phase preferably with at least some of the above parameters.

v) Regulations and Policies 44, preferably including, but not limited to, regulations set by government or para-government authorities, medical associations, etc, and policies set by the medical organization.

vi) Economical Considerations 45, preferably including, but not limited to, assessments of the cost, revenue, profitability, economical priorities and other non-medical considerations associated with each medical procedure and resource.

Typically, some of the information hosted by the database system 33, resides in an external database system 39, which is typically a part of a hospital information system (HIS), which is typically an ERP system. The information hosted in the HIS, or ERP system, can be an entire component of the database system 33, such as the patient information 40, or the personnel information 41, though some of these components may reside in the internal databases 38, such as the patient's medical priority, personnel authorizations to operate the operating-room decision-support center 32, etc.

Preferably, one of the inputs to the operating-room decision-support center 32 is the information input subsystem 46, which typically contains a reservations module 47 and a cancellations module 48. Typically, the information input subsystem 46 is also a part of an external system, such as a HIS or an ERP system.

Preferably, another input to the operating-room decision-support center 32 is via the monitoring subsystem 35. The monitoring subsystem 35 preferably continuously or repeatedly monitors and collects information about the status of every procedure and reports the status and the events to the scheduler subsystem 34.

The operating-room decision-support center 32, preferably continuously or repeatedly, processes the combined input information and database information and outputs, via the reporting subsystem 36, scheduling information. The scheduling information preferably contains, but not limited to:

i) Rescheduling of planned procedures or procedure phases;

ii) Alerts;

iii) Change of priorities;

iv) Forecasts, preferably including but not limited to:
1) Anticipated delays and cancellations;
2) Early than planned availability of resources including personnel, facilities and medical devices;
3) Early than planned requirements due to rescheduled procedures and procedure phases;
4) Anticipated emergencies;
5) Anticipated bottlenecks;

v) Contingency planning;

vi) Economical status and forecast information;

vii) Decision support information 49 and requests for manual considerations.

Preferably, the monitoring subsystem 35 and the reporting subsystem 36 contain user input and/or user output interfaces, typically implemented as user terminals, user input and/or output devices, etc.

Preferably, each staff member receives the relevant information according to authorization associated with the staff member personal identity, and/or with the position of the staff member (that is the profession or responsibility of the staff member), and/or with the location of the staff member.

It is appreciated that a bottleneck can be manifested in a shortage of a resource that may cause a delay in the execution of a procedure instance, or even cancellation of the procedure instance. A major bottleneck affects the execution of many procedure instances.

A bottleneck can typically occur when the scheduled plan fails. For example, when a procedure instance is not executed according to schedule. Namely, when a procedure instance takes a course which is different from the main course according to which the schedule is prepared and does not release (de-allocates) a specific resource in time. It is appreciated that the probability for bottlenecks grows with the number of resources being occupied past their scheduled release.

Preferably, the operating-room decision-support center 32 provides sufficient ‘slack time’ for procedure instances according to the probability of the various aberrations of each procedure. The scheduler subsystem 34 preferably also schedules procedure instances in a way that an aberration of a single procedure does not create too many bottlenecks.

A bottleneck can also occur due to an emergency, or another type of unplanned procedure instance. The scheduler subsystem 34 preferably also anticipates the probability of occurrence of certain emergency situations and provides sufficient resource availability to take care of such emergencies within reasonable time.

The operating-room decision-support center 32 preferably provides the decision support information 49 and requests for manual considerations preferably via a terminal 50 of the scheduler subsystem 36. One or more terminals 50 are preferably placed in a control center 51, where an authorized user 52, preferably a specially trained personnel, uses the decision support information 49 to perform required medically related decisions that apply to, are used as inputs to, the rescheduling process.

Preferably, the information provided by the reporting subsystem 36 provides information updates 53 for the information input 46. Preferably, each staff member receives the relevant information according to authorization associated with the staff member personal identity, and/or with the position of the staff member (that is the profession or responsibility of the staff member), and/or with the location of the staff member.

Preferably, the logger 37 logs (records) all the activities involved with operating the operating-room decision-support center 32, including, but not limited to: inputs to the operations monitoring subsystem 35, scheduling information provided by the scheduler 34, outputs provided by the reporting subsystem 36, and the interaction information with the terminals 50, preferably including the decision support information 49. Preferably, all logged information is recorded with corresponding time-stamps to record the time of each information item.

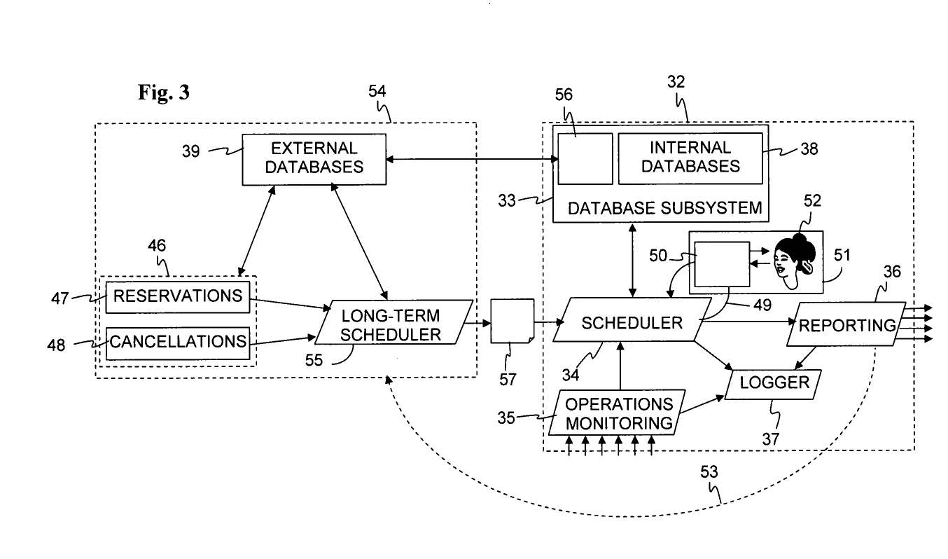

Reference is now made to FIG. 3, which is another simplified block diagram of the operating-room decision-support center 32, and a hospital information system (HIS) 54, within its environment.

FIG. 3 shows an example of the HIS 54 in the environment of the operating-room decision-support center 32. The HIS 54 of FIG. 3, is typically an ERP system, which contains the external databases 39, the reservations 47 and cancellation 48 modules, and a scheduler module 55. It is appreciated that the HIS typically additionally contains an electronic medical record (EMR) system, a logistics and resource management system, etc.

A database-interfacing module 56 within the operating-room decision-support center 32 enables the database subsystem 33 to interface to the database information in the external databases 39.

The scheduler module 55 is preferably a long-term scheduler and produces long term scheduling reports 57. The long term scheduling reports 57 preferably provide input information to the operating-room decision-support center 32. Preferably, the long term scheduling reports 57 provide input information to the scheduler subsystem 34. Based on the scheduling reports 57, update information from the monitoring subsystem 35 and information managed by the database systems 33, the scheduler subsystem 34 preferably provides online, or real-time, scheduling and associated information as described above.

Preferably, the operating-room decision-support center 32 supports the management and rescheduling of medical operation in the short term, preferably within a period of 24 hours. The rescheduling process performed by the scheduler subsystem 34 is preferably supervised by user 52. The operating-room decision-support center 32 preferably provides decision support information to the user 52.

Preferably, each staff member receives the relevant information according to authorization associated with the staff member personal identity, and/or with the position of the staff member (that is the profession or responsibility of the staff member), and/or with the location of the staff member.

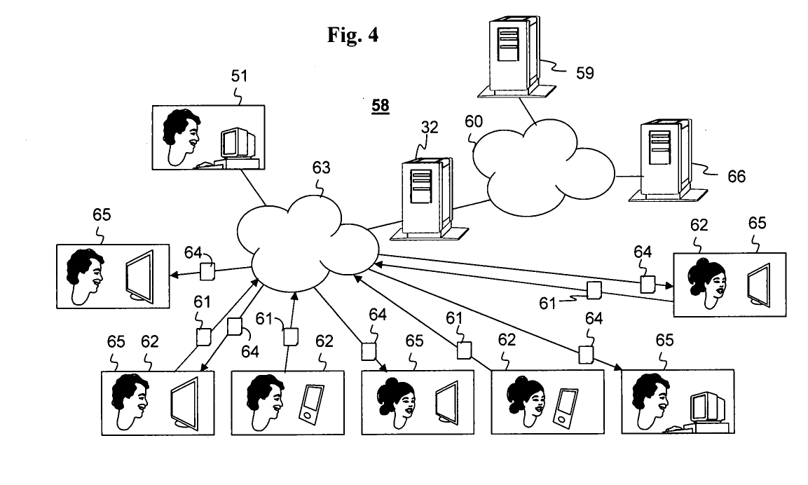

Reference is now made to FIG. 4, which is a simplified illustration of the operating-room decision-support center 32 within the environment of a medical organization 58, according to a preferred embodiment of the present invention.

As shown in FIG. 4, the operating-room decision-support center 32 preferably connects to an external database system 59, preferably a HIS or an ERP system, preferably via a network 60. The external database system 59 typically hosts patient record database, personnel database, operational database typically containing patient registration, bed management, patient release, etc.

The monitoring subsystem 35 (not detailed in FIG. 4) of the operating-room decision-support center 32 preferably receives input updates 61 from various resources 62 throughout the medical organization 58, preferably via a network 63.

The reporting subsystem 36 (also not detailed in FIG. 4) of the operating-room decision-support center 32 sends output updates 64 to various resources 65 throughout the medical organization 58, preferably also via the network 63. It is appreciated that a resource can provide input updates 61, or accept output updates 64 or both.

Typical resources 62 and 65 are patient registration and release, operating rooms, emergency rooms, recovery units (PACU), intensive care units, hospital wards, logistics and sanitary department, etc.

It is appreciated that the networks 60 and 63 can be any of a personal area network (PAN), a local area network (LAN), a metropolitan area network (MAN), a wide area network (WAN), a wired data transmission, a wireless data transmission, and combinations thereof.

Typically, resources 62 and 65 are manned by authorized users that can enter the input updates 61 and are responsible to look for, and respond to, output updates 64. However, resources 62 can also be medical devices and information processing systems that provide input updates automatically.

Preferably, each staff member receives the relevant information according to authorization associated with the staff member personal identity, and/or with the position of the staff member (that is the profession or responsibility of the staff member), and/or with the location of the staff member.

It is appreciated that output updates 64 to users can be provided via any type of appropriate communication system 66, such as, but not limited to, telephones, cellular telephones, pagers, radio communication devices, announcement system, messaging service such as short message service (SMS), voice mail, electronic mail, instant messaging, etc. It is appreciated that output updates 64 can also be provided to users of other information processing systems, such as a HIS or an ERP system, by interfacing the operating-room decision-support center 32 to the other information processing systems.

It is appreciated that the operating-room decision-support center 32 preferably features hardware and/or software redundancy to increase its resilience to hardware and software faults.

Preferably, the control center 51 enables specially trained and authorized users to manage the operating-room decision-support center 32. The control center 51 is preferably manned by the following professionals:
a medical director, preferably responsible for the management of the control center 51 and for real-time decisions;
a medical planning director, preferably responsible for managing the medical information database of the operating-room decision-support center 32, including defining medical procedures and phases, assigning medical priorities, associating resources, etc;
an operating room utilization director, preferably responsible for managing logistics aspects of a cluster of operating rooms;
a patient flow coordinator, preferably responsible for allocating beds and managing relevant logistics aspects, typically with respect to admission, pre-op, operating room, PACU and additional stations along the patient flow;
a scheduling officer, preferably responsible for executing scheduling runs, simulation runs, etc;
a technical operator, preferably responsible for the technical side of operating the control center 51.

It is appreciated that in certain situations one or more of the tasks described above (as professionals) can be performed by more than one user. It is also appreciated that in certain situations one or more of users in the control center 51 can perform more than one task.

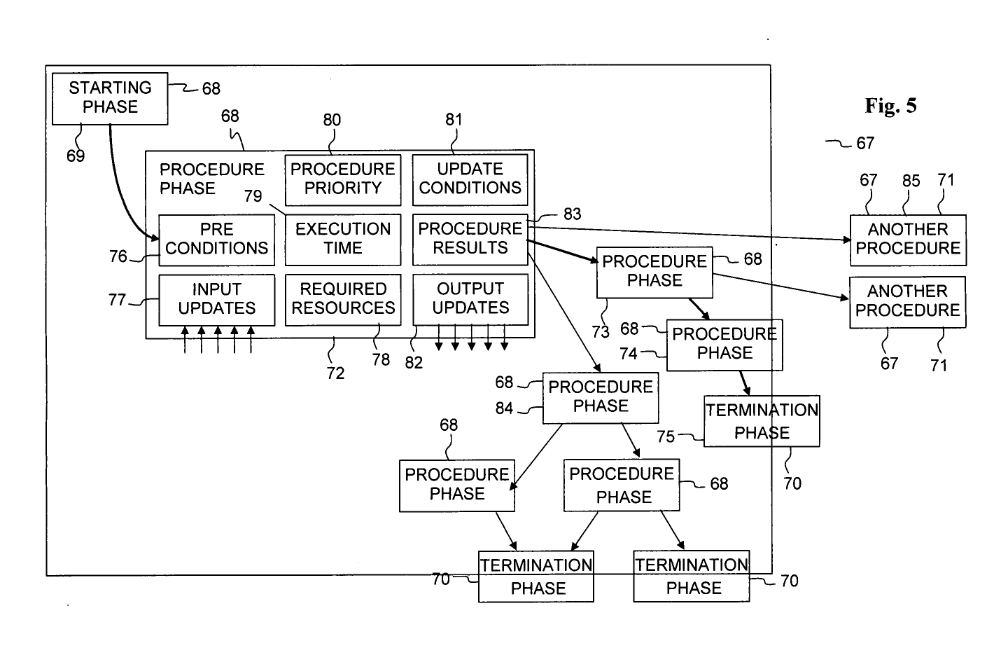

Reference is now made to FIG. 5, which is a simplified block diagram of a medical procedure data structure 67, used by the operating-room decision-support center 32, according to a preferred embodiment of the present invention.

As shown in FIG. 5, the medical procedure data structure 67 preferably contains a sequence of procedure phases 68, typically in a tree-like structure. Preferably, the medical procedure data structure 67 starts with a starting phase 69 and ends in a termination phase 70. Alternatively, the medical procedure may continue into another medical procedure such as procedures 71. Preferably, the medical procedure data structure 67 contains a main sequence of phases, such as the sequence made of phases 69, 72, 73, 74, and 75. Other sequences of procedure phases 68 typically represent aberrations of the medical procedure. It is appreciated that such may have a dramatic effect on the outcome and\or the length of the respective procedure.

Preferably there is a single starting phase, however, it is appreciated that in an emergency situation, or when a first procedure develops into a second procedure, the second procedure may begin in a procedure phase that is not the normal starting phase.

It is appreciated that in some procedures, two or more phases may be performed concurrently. For example, performing a biopsy in the course of a surgical operation and providing biopsy results before the operation is over.

As shown in FIG. 5, the procedure phase 72 contains the following elements:
Pre-conditions 76 preferably define a list of mandatory requirements for the procedure to begin. Such as receiving specific results of prior medical examinations, preparation of the patient for the operation, availability of specific medical devices, availability of certain members of the medical staff, either present or in a stand-by position, etc. Each such requirements is preferably associated with a deadline at which the requirements should be met and the consequences of missing this deadline, such as delay or cancellation of the phase or the entire procedure or branching to another phase 68 or procedure 67. Typical pre-conditions involve aspects of medical operation, anesthesia, medical assistance, sanitary, and transportation.
Input updates 77 preferably define the updates that affect the scheduling and/or the execution of the procedure phase 72.
Required resources 78 preferably lists all the resources required for the procedure phase 72. Such resources can be medical professionals, medical facilities, medical devices, etc.
Execution time 79 preferably defines the anticipated period that the resources defined as the required resources 78 should be allocated to the procedure phase 78. Preferably, the execution time 79 is a table of execution time statistics, enabling the scheduler subsystem 34 to anticipate the probability of availability or unavailability of various resources.
Procedure phase priority 80 preferably defines the medical priority of the procedure phase 72. The scheduler subsystem 34 preferably considers the phase priority 80 when scheduling the procedure 72 and the resources listed as the required resources 78.
Update conditions 81 preferably defines a list of conditions, rules, events, etc that are monitored during the execution of the of the procedure phase 72 and the actions that should be taken once such conditions, rules, events, etc is manifested. Such actions can be de-allocating a resource, sending an update message, etc.
Output updates 82 preferably lists update information and messages that should be sent out, preferably by the reporting subsystem 36, and preferably their addresses.
Procedure results 83 preferably defines branching into one or more procedure phases 68 to which the medical procedure 67 should follow, such as phases 73, 84 and procedure 85, following phase 72. Procedure results 83 preferably contains the conditions and situations resulting from the execution of procedure phase 72 that trigger transition to the next phase. Preferably, each of the conditions and situations is associated with a probability value for the conditions or situations to occur.

It is appreciated that the operating-room decision-support center 32 preferably schedules each procedure phase 68 according to the requirements expressed within at least the data elements of the data-structure 67, namely:
i) anticipated realization of pre conditions 76;
ii) priority 80;
iii) execution time 79; and
iv) availability of required resources 78.

It is appreciated that the procedure is associated with a probability value for the procedure to occur within a predefined time period, such as the next 24 hours. It is also appreciated that the procedure is associated with a probability value and overall average time length for performing the procedure. This overall probability and average time length resulting from the combined branching probability and execution time 79 for each phase of the main sequence of phases of the procedure. It is further appreciated that each other possible sequence of the procedure is associated with a probability value and overall time length for performing the specific phase sequence of the procedure.

For example, on the average a specific operation takes one hour. However, a certain known complication can result in the operation taking three hours. Another complication may result in a sudden death and the operation is over in 40 minutes.

Thus, it is possible to assess the probability of various situations and aberrations of a planned procedures and their respective execution time, and to evaluate the probability of the resulting bottlenecks, as well as early de-allocation of resources.

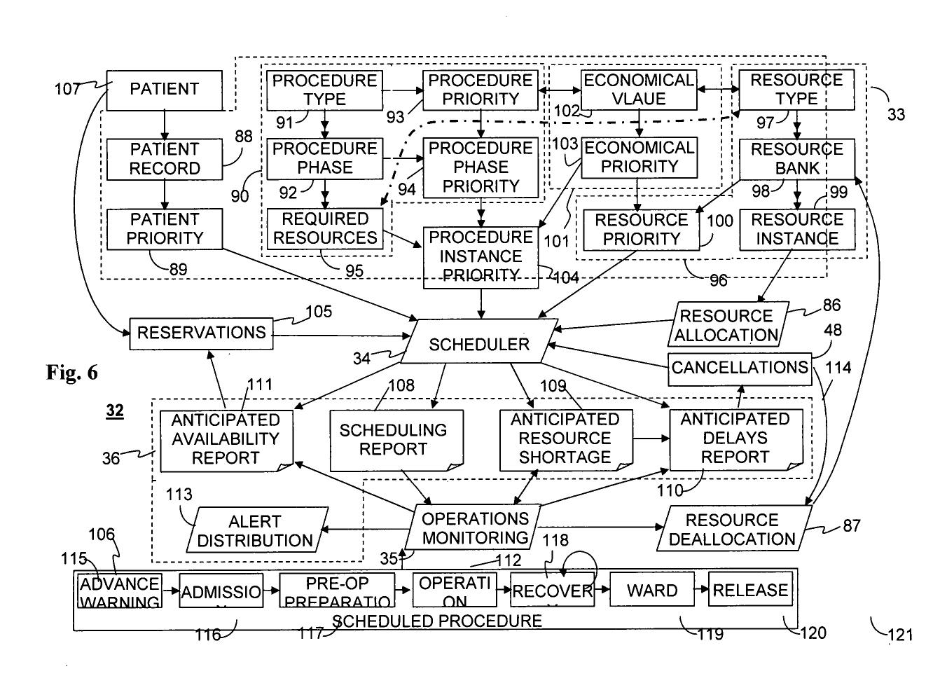

Reference is now made to FIG. 6, which is another simplified block diagram of the operating-room decision-support center 32.

As shown in FIG. 6, the operating-room decision-support center 32 preferably contains the four main parts: the database subsystem 33, scheduling subsystem 34, monitoring subsystem 35 and reporting subsystem 36.

Typically and preferably, the Scheduling subsystem 34 contains resources allocation 86 and de-allocation 87 modules.

The databases subsystem 33 contains several databases. Typically, some of the database resides directly within the operating-room decision-support center 32 while some of the databases can be a part of an external system, such as a HIS or an enterprise resource planning system (ERP), or any other information processing system, such as a patient record database 88.

The operating-room decision-support center 32 preferably adds patient's medical priority value 89 to the patient's record 88. It is appreciated that the patient's medical priority 89 can physically reside within an external patient's record database or within a database management system of the operating-room decision-support center 32.

The databases subsystem 33 also preferably contains a medical procedure database 90. The medical procedure database 90 preferably contains a definition of a plurality of medical procedures and protocols 91. Each medical procedure or protocol preferably contains a plurality of phases 92. Each procedure or protocol and each phase is preferably assigned a priority value, 93 and 94 respectively. Each procedure or protocol and each phase is preferably also assigned a list of required resources 95.

It is appreciated that a procedure type, or protocol, can have a plurality of phases organized sequentially, or in a tree structure. It is also appreciated that a procedure type can branch to, or initiates, another procedure type.

The databases subsystem 33 also preferably contains a resource database 96. The resource database 96 preferably contains a list of resource types 97, for each resource type 97 there is a list 98 of resource instances that are generally available for the medical organization, and a record for each such resource instance 99. Each resource type 97, and consequently each resource instance 99, is assigned a resource priority 100.

The databases subsystem 33 also preferably contains an economy database 101, preferably containing economical values 102 for each medical procedure type 91 and for each medical resource type 97, and a resulting economical priority 103.

The databases subsystem 33 also preferably contains a procedure instance priority 104, preferably resulting from the combination of the economical value of the procedure and the resource priorities of the resources required for the specific procedure.

As a reservation 105 of a medical procedure instance 106 is made for a patient 107, the scheduling subsystem 34 preferably analyzes at least the following information:
1. the medical procedure 91, its phases 92, and their priorities 93 and 94;
2. the required resources 95 and 97, their availability 98 and 99 and their priorities 100;
3. the economical value and priorities of the procedure and the resources, 102, 103 and 104 respectively; and
4. the patient's priority 89.

Consequently, the operating-room decision-support center 32 preferably provides the following reports:

1. Schedule report 108, scheduling the reserved procedure instance;
2. Resource shortage report 109, describing possible shortage of required resources;
3. Delays report 110, anticipating possible delays resulting from shortage of required procedures; and
4. Anticipated availability report 111, anticipating possible availability, or lack of use, of resources.

It is appreciated that the reporting is provided in various ways, including reporting a single instance or a list of instances, reporting online or offline, etc.

Consequently, when the time comes for executing the scheduled medical procedure 106, the monitoring subsystem 35 preferably monitors 112 the execution of the procedure. The monitoring subsystem 35 preferably compares the monitored information with the scheduling plans, and preferably provides the appropriate users, preferably via the reporting subsystem 36, information resulting from the progress of the monitored medical procedures. Such information preferably includes:
1. timely alerts 113 to entities (e.g. wards, personnel, etc.) associated with the next phases of the procedure 106,
2. anticipated resource shortage 109 due to delays in the progress of the procedure 106;
3. anticipated delays in further phases and subsequent procedures due to delays in the progress of the procedure 106;
4. anticipated availability for unscheduled procedures, for example due to early de-allocation of resources due to early conclusion of the procedure 106; and
5. de-allocates 87 resources that are no longer needed for the procedure 106.

Consequently, some future scheduled procedures can be cancelled, resulting 114 in the de-allocation of their resources, and optional rescheduling.

It is therefore appreciated that the scheduler subsystem 34, the monitoring subsystem 35, and that the reporting subsystem 36, are preferably connected in a continuous, or repetitive, process of collecting information, analyzing the information and disseminating the information and the analysis to the appropriate medical personnel in due time, so as to provide timely alerts and decision support. The reporting subsystem 36 is thus preferably equipped to receive instructions from authorized medical personnel, as an additional source for the scheduling process.

The medical procedure instance 106 preferably begins with an advance warning 115. The advance warning is distributed (via the alert distribution module 113) to all entities involved in the execution, including the patient 107, including a patient outside the medical organization, such as a patient at home. For example: the advance warning checks that the patient is about to arrive, checks that the patient follows the diet required by the procedure, or the procedure phase, anticipates cancellation, etc. The monitoring subsystem 35 monitors the response to the advance warning 115 to verify that the next phases of the procedure instance 106 are still according to schedule.

The medical procedure instance 106 preferably continues with an admission step 116, in which the patient is admitted to the hospital, or transferred to another ward within the hospital.

The medical procedure instance 106 preferably continues with a pre-operation preparation step 117, in which the patient is prepared for the medical operation itself. At this stage, preferably, the availability of all required resources for the following phases is checked and warning messages are delivered to all wards and personnel to prepare for the execution of the medical procedure itself.

The medical procedure instance 106 preferably continues with a sequence of medical operation phases 118, such as phases 68 described in accordance with FIG. 5. During the execution of the phases 118, preferably at the end of each phase, resources that are no longer required are de-allocated. Preferably, before the sequence of phases 118 ends, warning messages are delivered to all wards and personnel to prepare for the execution of the next stage of the medical procedure instance 106.

The medical procedure instance 106 preferably continues with the transfer of the patient to a recovery room (step 119), also known as PACU, or, alternatively to the ICU. Later the patient is preferably transferred to a hospital ward (step 120), and later released from the hospital (step 121).

It is appreciated that a complete medical treatment may involve a sequence of medical procedures such as medical procedure instance 106, or, in other facility, a complete medical procedure instance may involve a structure repeating the structure described for medical instance 106.

It is appreciated that the medical procedure instance 106 can be aborted at any stage, resulting in the de-allocation of all the resources allocated to the phase being aborted, and preferably to all later phases.

It is appreciated that the medical organization using the operating-room decision-support center 122 is typically a hospital. However, the operating-room decision-support center 123 can also be used by larger organizations, or by smaller organizations. The operating-room decision-support center 124 can also serve a clinic, or a chain of clinics, or a group of hospitals, or a region, such as a town. It is appreciated that the operating-room decision-support center 125 can improve the efficiency of operating such organization, reduce the queue for treatments, reduce the cost of providing treatments, or improve the quality of the medical service. It is appreciated that the operating-room decision-support center 126 can be effective in managing triage, especially for a large-scale situation involving several hospitals.

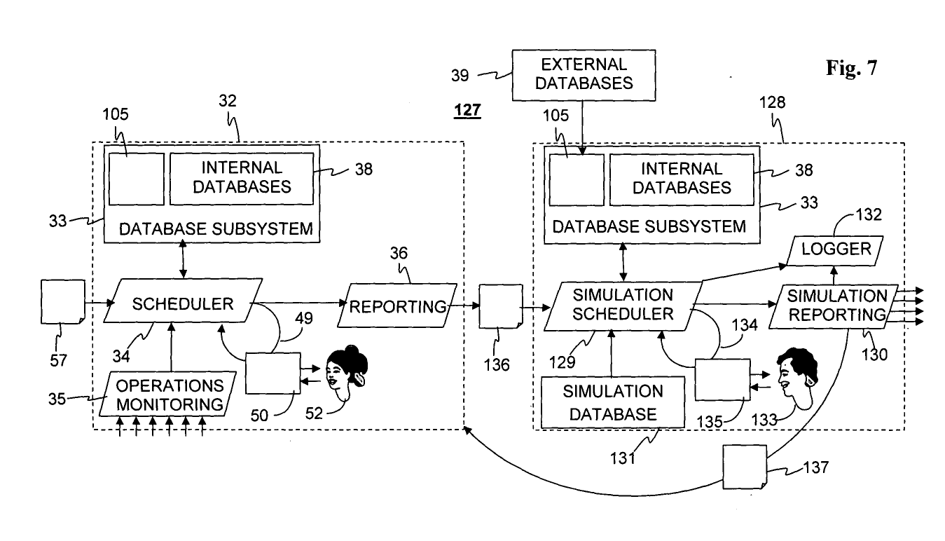

Reference is now made to FIG. 7, which is a simplified block diagram of an enhanced operating-room decision-support center 127, according to a preferred embodiment of the present invention.

The enhanced operating-room decision-support center 127 preferably includes the operating-room decision-support center 32 and a simulation system 128. The simulation system 128 preferably includes a database subsystem 33, a simulation scheduler subsystem 129, a simulation reporting subsystem 130, and a simulation database 131. Preferably, but optionally, the simulation system 128 also includes a logger 132.

It is appreciated that the simulation system 128 is preferably very similar in its internal structure to the operating-room decision-support center 32, except that the monitoring subsystem is replaced by the simulation database 131, which preferably feeds simulation scenarios to the scheduler subsystem 129. The results of the simulation scheduling provided by the simulation scheduler subsystem 129 are reported by the simulation reporting subsystem 130 to all authorized personnel. At least one authorized user 133 is able to observe the results of the simulation online and modify (134) simulation parameters via a user interface 135.

Preferably, each staff member receives the relevant information according to authorization associated with the staff member personal identity, and/or with the position of the staff member (that is the profession or responsibility of the staff member), and/or with the location of the staff member.

Preferably, the simulation reporting subsystem 130 contains user input interface and/or user output interface, typically implemented as user terminals, user input and/or output devices, etc.

As shown in FIG. 7, the operating-room decision-support center 32 feeds scheduling reports 136 to the simulation system 128. The simulation system draws scenarios of possible future developments and simulates possible future situations. The simulation system 128 preferably provides corrective information 137 to the operating-room decision-support center 32, to perform rescheduling that avoid unwanted possible situations and contingency planning.

For example, the simulation database contains a description of an emergency situation. The simulation system 128 simulates the availability, or unavailability, of resources required to manage the emergency situation. Preferably, such simulations take in account constraints and other hospital policies associated with an emergency situation.

For example, the emergency situation can be a person suffering a heart-related condition arriving at the hospital's emergency room. The hospital patient care policy is to be able to transfer the patient to a cardiac operating room within 15 minutes of his arrival. Therefore, a cardiac operating room must be available, at all times, within 15 minutes.

The simulation database 131 preferably contains a plurality of anticipated situations such as:
expected arrival of emergency situations;
possible aberration of scheduled procedures or undergoing execution;
failure of medical devices;
unplanned absence of medical staff;
etc.

Each type of the simulation situation is associated with statistical parameters, such as probability of occurrence. Each type of the simulation situation is associated with a priority. Preferably, higher priority situations are simulated first. Preferably, the simulations are based on information available from the database system 33, such as the medical procedure database 90 (FIG. 6). containing medical procedures 67 (FIG. 5), typically incorporated within the medical database 43 (FIG. 2).

The results of the simulations are compared with the hospital's policies and government regulations such as:
quality of service;
staffing—such as:
   minimum ratio of personnel to patients in each ward;
   availability of personnel of each profession;
response time—such as:
   average time to treat arriving emergency, according to type;
   average waiting time for an examination, according to type;
maximum time of unavailability of a resource of a specific type;
etc.

Preferably, when resolving lack of compliance with policies and regulations, higher priority situations are resolved first.

Additionally the simulation system 128 performs the following analysis and forecast:
forecast of possible or potential future bottlenecks and critical paths;
cost of bottlenecks;
analysis of sensitivity to uncertainty, e.g. the probability of various bottlenecks;
etc.

The logger 132 preferably logs (records) all the activities involved with operating the simulation system 128, including, but not limited to: inputs (scheduling reports 136) from the operating-room decision-support center 32, inputs provided by the simulation database 131, scheduling information provided by the simulation scheduler 129, outputs provided by the simulation reporting subsystem 130, and the interaction with the user interface 135. Preferably, all logged information is recorded with corresponding time-stamps to record the time of each information item.

It is appreciated that the simulation system 128 enables a user, preferably using the user interface 135, to retrieve any components of the logged information, and/or to perform a playback of the logged information, preferably in a synchronized manner. This playback enables the user to review the sequence of selected events, inputs and outputs, with their time-stamps, and to compare them to the schedule and/or to the rules, regulations and policies.

It is appreciated that the similarity between the simulation system 128 and the operating-room decision-support center 32 encourages the incorporation of one within the other. Namely, adding the simulation database 131 to the internal databases 38, adding the simulation functions of the simulation scheduler 129 to the simulation subsystem 34, and adding the simulation reporting functions of the simulation reporting 130 to the reporting subsystem 36. In this case, the operating-room decision-support center 32 functions as the simulation system 128 whenever it is not busy with the real-time scheduling.

It is therefore appreciated that the present invention, preferably in the form of the operating-room decision-support center 32, or in the form of the enhanced operating-room decision-support center 127, preferably including the operating-room decision-support center 32 and a simulation system 128, enables a hospital, or a similar medical organization, to improve the efficiency and the quality of its operations. Particularly, the present invention provides:
improving the management of patient flow through the medical organization;
real-time scheduling of medical procedures and resources;
decision support information for manual scheduling of medical procedures and resources;
forecasting possible situations resulting from the combination of planned operations and unplanned situation;
evaluating the economical aspects of various scheduling scenarios;
distributing advance warning and alarms, in a timely manner, to relevant personnel, anticipating developments and requirements;
etc.

The scheduling, whether long-term or real-time, is preferably based on priorities, preferably a combined priority of at least some of:
The priority associated with the medical procedure,
The patient's priority expressing the overall medical condition of the patient;
The priority of each resource, particularly priorities of personnel and priorities of medical devices, typically expressing the maximum allowed period of unavailability of a particular resource or type of resource.

The priority, particularly the combined priority, eventually expresses the maximum time the specific instance of the medical procedure, typically associated with a specific patient, can be delayed.

Thus, the present invention enables scheduling patients or medical procedures in excess of the hospital's capacity (overbooking), and/or to stand-by. Then, the present invention enables rescheduling the operation of the hospital in real-time, to take advantage of cancellation and early completing of medical procedures, to perform overbooked or stand-by medical procedures.

It is appreciated that excess scheduling, such as overbooking and stand-by, is associated with probability of occurrence of emergencies and cancellations and deviations from the average time of execution (i.e. normal course, or main sequence of phases) of the planned procedures.

For example, the operating-room decision-support center 32 can assume that there is a certain probability for an emergency situation and therefore pre-allocate resources for this emergency situation. Suppose that the remaining resources are sufficient for the execution of ten procedure instances within a shift of, say, eight hours.

The operating-room decision-support center 32 can assume that there is a 90% probability that one procedure instance of the ten procedure instances planned for the upcoming shift would be cancelled, and therefore schedule an overbooked eleventh procedure instance.

The operating-room decision-support center 32 can further assume that there is a 50% probability that another (second) procedure instance of the ten procedure instances planned for the upcoming shift would be cancelled, and therefore schedule a twelfth procedure instance in stand-by.

Preferably, the main difference between the overbooked and the standby situation is the time it takes to have the patient ready for the procedure.

Similarly, instead of a procedure instance being canceled, the procedure instance has a certain probability for taking a shorter course resulting in resources being de-allocated ahead of schedule. Consequently, some scheduled procedures may be rescheduled ahead of their time, or even postponed, so that enough resources are can be allocated to an additional pending procedure instance. Based on the planned procedures instances and the combined probabilities it is possible to predict which procedures are most likely to be added, and put these procedures in stand-by. For example, it is possible to predict which resources are most likely to be de-allocated and grouped for concurrent availability and select pending procedure instances that can make use of this availability, and put one or more in stand-by.

Additionally, the present invention enables simulation of probable situations and events and assessing the influence of such situation and events on the operations of the medical organization. Particularly, the present invention enables anticipation of bottlenecks, resource shortage, delayed execution of planned and unplanned procedures, and lack of compliance with hospital policies and government regulations. For example, anticipating shortage of personnel according to specific professions.

Based on the above described simulation and scheduling abilities, the present invention enables contingency planning for selected situations and events, including, but not limited to, planned delay or cancellation of low priority operations to provide required resource availability for high priority operations. Preferably, the present invention enables a user to prepare, while using real-time simulation, a list of possible alternative solutions and recommendations, to a predefined list of emergency situations and contingency events.

When using the medical real-time patient flow monitoring and reporting system 10 or the operating-room decision-support center 32 to schedule a new medical event, or when using the simulation system 128 to simulate the potential effect of a possible medical event on a current schedule, the system preferably use a method of multi-hypothesis solutions. Multi-hypothesis solutions preferably involve comparing several possible scheduling solutions. For example, the difference between scheduling solutions can result from the selection of scheduling rules or the order in which the selected scheduling rules are processed. The Multi-hypothesis solutions method can be executed in any of the following manners:
Automatically executing all relevant hypothesis;
Enabling the user to select or de-select hypothesis from a list of available hypothesis;
Automatically imposing or eliminating one or more hypothesis according to a predefined situation;
Automatically selecting a preferred hypothesis according to a predefined situation;
Enabling the user to create or to modify a hypothesis by adding rules, deleting rules, or reordering the execution of rules.

Preferably, the system (10, 32 or 128) displays to the user the results of the multi-hypothesis solutions method in at least one of the following methods:
For each hypothesis the effect on a selected attribute, such as efficiency, cost, manpower, etc.
For each hypothesis, the effect on the most adversely effected attribute;
A preferred scheduling solution according to a selected parameter.
A preferred predefined scheduling solution or contingency plan.

Additionally, the operating-room decision-support center 32 performs logging (recording) of all activities involved, including, but not limited to,
Scheduling runs, simulation runs, scheduling decisions and all activities within the control center 51;
Inputs to the monitoring subsystem 35 and outputs via the reporting subsystem 14;
Deviations between the schedule and the actual execution;
Statistics, such as average patient waiting time, average resource idle time, etc.

Additionally, the operating-room decision-support center 32 enables training of users by running recorded activities and simulations.

It is appreciated that the operating-room decision-support center 32 enables a user, preferably using one of the terminals 50 in the control center 51, to retrieve any components of the logged information, and/or to perform a playback of the logged information, preferably in a synchronized manner. This playback enables the user to review the sequence of selected events, inputs and outputs, with their time-stamps, and to compare them to the schedule and/or to the rules, regulations and policies.

It is appreciated that additionally, the operating-room decision-support center 32 enables a user, preferably using one of the terminals 50 in the control center 51, to perform a simulated playback of the logged information. In this simulated playback the user can change, remove or add selected data items to review their effect on the resulting situation. This enables the user to evaluate the effects of alternative scheduling decisions on resource availability, queues and delays in providing medical treatment, triage considerations, and compliance with relevant rules, regulations and policies. In this way the medical organization can educate and train its medical staff, and especially the medical staff involved in operating the operating-room decision-support center 32, to improve the medical service and reduce its cost.

Thus the present invention is effective in increasing the patients' well being, increasing the hospital's capacity, reducing the cost of operating the hospital, reducing staff overtime and stress, etc.

It is expected that during the life of this patent many relevant medical devices and systems will be developed, and many medical procedures will be developed, therefore and the scope of the terms herein, particularly of the terms “medical procedure”, “medical procedure phase”, and “medical resources, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A patient flow monitoring method comprising:
a) defining a medical procedure type comprising a sequence of phases;
b) associating said medical procedure type with a patient to form a medical procedure instance;
c) monitoring execution of said medical procedure instance; and
d) reporting progress of said execution of said medical procedure instance in real-time.

2. A patient flow monitoring method according to claim 1 wherein said sequence of phases comprises a branching.

3. A patient flow monitoring method according to claim 1 wherein said phase is associated with at least one of:
a staff member responsible to report a progress of said phase; and
a staff member responsible to receive a report associated with a progress of said phase.

4. A patient flow monitoring method according to claim 1 wherein said staff member is identified by at least one of:
personal identity;
position identity; and
location identity.

5-19. (canceled)

20. Decision A decision support method for managing a plurality of concurrent medical procedures, the method comprising:
a) defining a plurality of medical procedure types;
b) defining a sequence of phases for said medical procedure types;
c) associating at least one medical resource type with at least one of said phases of said at least one of said medical procedure types;
d) providing a list of available medical resource instances;
e) assigning at least one medical procedure type to a patient to form a medical procedure instance;
f) assigning at least one medical resource instance to at least one phase of at least one medical procedure instance, said medical resource instance corresponding to said medical resource type associated with said phase; and
g) scheduling at least one phase of at least one medical procedure instance according to availability of an instance of said medical resource type.

21. Decision support method according to claim 20 additionally comprising:
h) reporting at least one of availability and unavailability of a medical resource type for at least one phase of at least one medical procedure instance.

22. Decision support method according to claim 20 additionally comprising:
h) monitoring execution of at least one of said scheduled medical procedures; and
i) reporting at least one of:
i) availability of a medical resource;
ii) unavailability of a medical resource; and
iii) anticipated requirement for a medical resource;
for at least one phase of at least one medical procedure instance.

23. Decision support method according to claim 20 additionally comprising at least one of:
j) rescheduling at least one of said phases; and
k) enabling a user to reschedule at least one of said phases;
wherein at least one of said rescheduling of a phase, and said enabling a user to reschedule, being according to at least one of:
i) said availability of medical resources;
ii) said unavailability of medical resources; and
iii) said anticipated requirement for medical resources.

24-33. (canceled)

34. A patient flow monitoring system comprising:
a) a database unit containing a plurality of medical procedure types wherein each medical procedure comprises a sequence of phases;
b) a user interface operative to enable a user to associate at least one of said medical procedure types with at least one patient to form a medical procedure instance;
c) a monitoring unit operative to monitor execution of said medical procedure instance; and
d) a reporting unit operative to provide a user with a progress report execution of said execution of said medical procedure instance in real-time.

35. A patient flow monitoring system according to claim 34 wherein said monitoring unit comprises a user input device operative to receive from a user an indication of said execution of said medical procedure instance.

36. A patient flow monitoring system according to claim 34 wherein said reporting unit comprises a user output interface operative to provide a user with an indication of said execution of said medical procedure instance.

37. A patient flow monitoring system according to claim 34 wherein at least one of said monitoring unit and said reporting unit comprise a user identification module operative to identify said user according to at least one of:
personal identity; and
position identity; and
location identity.

38-45. (canceled)

46. A decision support system comprising:
a) a database unit containing a plurality of database records, each record describing one of:
i) a medical procedure comprising a plurality of phases;
ii) a medical resource type;
iii) a medical resource instance of said medical resource type; and
iv) a patient;
b) a first user interface operative to enable a user to associate at least one of said medical resource types with at least one of said phases;
c) a second user interface operative to enable a user to associate one of said medical procedures with one of said patients to form a medical procedure instance;
d) a third user interface operative to enable a user to assign at least one of said medical resource instances with one phase of said medical procedure instances according to said medical resource type associated with said phase and according to availability of said medical resource instance; and
e) a user output interface operative to provide indication of scheduling of execution of said phase;
wherein said decision support system is operative to schedule a plurality of concurrent medical procedures.

47. A decision support system according to claim 46 wherein said user output interface is additionally operative to provide said indication of scheduling according to at least one of:
i) a type of medical procedure;
ii) a phase of medical procedure;
iii) a type of medical resource;
iv) a medical staff member; and
v) a patient.

48. A decision support system according to claim 46 additionally comprising:
f) a processing module operative to process said database to provide a schedule of said plurality of said medical procedure instances according to said availability of said medical procedure instances.

49. A decision support system according to claim 46 additionally comprising:
g) a monitoring module operative to monitor execution of said scheduled medical instances and to report at least one of:
i) availability of medical resources;
ii) unavailability of medical resources; and
iii) anticipated requirement for medical resources;
for at least one phase of at least one medical procedure of at least one of said plurality of patients.

50-51. (canceled)
